(19) United States
(12) Patent Application Publication
(10) Pub. No.: US 2024/0351637 A1
(43) Pub. Date: Oct. 24, 2024

(54) Front End for a Passenger Car

(71) Applicant: Mercedes-Benz Group AG, Stuttgart (DE)

(72) Inventors: Patrick MANGOLD, Erkenbrechtsweiler (DE); Alexander HUEBNER, Sulzbach (DE); Emanuel LADNER, Deckenpfronn (DE); Klaus HEID, Sindelfingen (DE)

(21) Appl. No.: 18/684,441

(22) PCT Filed: Jul. 12, 2022
(86) PCT No.: PCT/EP2022/069442

§ 371 Date: Feb. 16, 2024

(30) Foreign Application Priority Data
Aug. 17, 2021 (DE) 10 2021 004 205.0

(51) Int. Cl. B62D 21/15; B60R 5/02; B60R 13/00; B62D 25/10

(52) U.S. Cl. CPC B62D 21/152; B60R 5/02; B62D 25/105; B60R 13/00

(57) ABSTRACT

A front end for a vehicle has a cladding element which can be displaced between a cladding position, in which a front end region which is connected to the cladding element towards the rear in the longitudinal direction of the vehicle is covered towards the front in the longitudinal direction by the cladding element, and a stowed position, which exposes the front end region towards the front. The cladding element has, in the cladding position, a lower edge region in the vertical direction of the vehicle and a cladding region connected to the lower edge region upwards in the vertical direction. The cladding element can be displaced from the cladding position into the stowed position such that when the cladding region is pivoted forwards in the longitudinal direction and downwards in the vertical direction, the lower edge region can be retracted backwards in the longitudinal direction into a receiving chamber.

### BACKGROUND AND SUMMARY OF THE INVENTION

The invention relates to a front end for a passenger car.

U.S. Pat. No. 10,676,137 B2 discloses a motor vehicle having a body having floor elements that are positioned along a base of the body and which extend along an uninterrupted path from a front end of the motor vehicle to a rear end of the motor vehicle. A vehicle can be taken as known from U.S. Pat. No. 10,730,441 B2, having a body structure that defines a front boot having a front opening. A radiator grille surrounds the front opening in a closed position and can be pivoted along an upper edge around a vertical hinge or a horizontal hinge. A front structure of a motor vehicle is further known from DE 10 2008 039 972 A1. DE 102 58 626 B4 discloses a motor vehicle, having a radiator cladding which is pivotably mounted on a vehicle body around a horizontal pivot axis running transversely to the longitudinal axis of the vehicle and arranged on or in a lower region of the radiator cladding. A passenger car can additionally be taken as known from WO 2016/177440 A1, having a front-end support having at least one cross member and at least two lateral, front strut elements which are connected to each other via the cross member and which extend downwards in the vertical direction of the vehicle away from the cross member.

The object of the present invention is to create a front end for a passenger car and a passenger car having such a front end, such that a particularly advantageous usability can be implemented.

A first aspect of the invention relates to a front end for a passenger car. The front end comprises at least one front cladding element, which can be displaced between a cladding position and at least one stowed position. In the cladding position, a front end region of the front end connected to the cladding element towards the rear in the longitudinal direction of the vehicle is covered, i.e., overlapped, towards the front in the longitudinal direction of the vehicle, in particular directly, by the cladding element. Thus, for example, if an object, e.g., a transport object is arranged in the front end region when the cladding element is in the cladding position, then the object is overlapped, and thus covered towards the front in the longitudinal direction of the vehicle, in particular directly, by the cladding element. In the stowed position, the cladding element exposes at least the front end region towards the front in the longitudinal direction of the vehicle, such that the front end region is no longer covered by the cladding element towards the front in the longitudinal direction of the vehicle in the stowed position of the cladding element. At least in the cladding position, the cladding element has a lower edge region in the vertical direction of the vehicle, on which for example the cladding element ends downwards in the vertical direction of the vehicle in the cladding position. In other words, at least in the cladding position, the edge region is a lower edge region of the cladding element, in particular the lowest edge region of the cladding element in the vertical direction of the vehicle. The cladding element further has a cladding region, which is connected, in particular directly, to the edge region, and which, at least in the cladding position, is connected, in particular directly, to the lower edge region upwards in the vertical direction of the vehicle. In particular, it is conceivable that the cladding element can be displaced, i.e., can be moved, relative to at least one component, in particular relative to at least one structural element, of the front end between the cladding position and the stowed position. It can for example be provided that the cladding element is fixed to the component, in particular to the structural element, such that it can be displaced between the stowed position and the cladding position.

It is provided according to the invention that the cladding element can be displaced from the cladding position into the stowed position, which in particular is lower than the cladding position, such that when at least the cladding region is pivoted forwards in the longitudinal direction of the vehicle and downwards in the vertical direction of the vehicle, the lower edge region can be retracted backwards in the longitudinal direction of the vehicle into a corresponding receiving chamber, so that a particularly advantageous usability of the front end, and thus of the passenger car as a whole can be implemented. In other words, in order to displace the cladding element out of the cladding position into the stowed position, the cladding element is pivoted, in particular around a pivot axis running in the transverse direction of the vehicle, and preferably relative to the component, such that the cladding region is pivoted forwards in the longitudinal direction of the vehicle and downwards in the vertical direction of the vehicle, and the lower edge region in the cladding position is retracted rearwards in the longitudinal direction of the vehicle, in particular in comparison with the stowed position, into the receiving chamber, in particular relative to the component. It is conceivable that the cladding region is initially or first of all pivoted forwards in the longitudinal direction of the vehicle and downwards in the vertical direction of the vehicle, and the cladding element is then moved, in particular translationally, backwards in the longitudinal direction of the vehicle, such that the edge region is retracted backwards in the longitudinal direction of the vehicle into the receiving chamber, or the cladding region pivots and the lower edge region retracts into the receiving chamber at least partially simultaneously.

Retracting the lower edge region backwards in the longitudinal direction of the vehicle into the receiving chamber is in particular understood to mean that the cladding element, in particular as a whole, is moved backwards in the longitudinal direction of the vehicle, in particular relative to the component, whereby the lower edge region is retracted into the receiving chamber. In the stowed position, in which the cladding element is advantageously stowed, the cladding element thus exposes the front end region particularly advantageously such that the front end region is not only exposed forwards in the longitudinal direction of the vehicle, but rather, in the stowed position, the cladding element also does not protrude excessively far forwards in the longitudinal direction of the vehicle from the front end region, or the cladding element in the stowed position does not protrude or does not protrude excessively far forwards in the longitudinal direction of the vehicle from the front end region in the stowed position. If the cladding element is in the stowed position, a particularly advantageous accessibility to the front end region is thus created for a person standing in front of the passenger car, i.e., in front of its front section, because the person can position themselves particularly close to the front end region. In order to reach the front end region, the person does not then need to bend or stoop excessively, because the cladding element located in the stowed position is not in the region of the stomach or legs of the person. The person can thus reach the front end region particularly well without being hindered by the cladding element, i.e., in particular without the cladding element touching the legs and/or the stomach of the person.

In one embodiment of the invention, an upper cross member is provided, which can be displaced between a supporting position and at least one access position, in particular relative to the specified component of the front end, so that a particularly advantageous accessibility to the front end region and a particularly advantageous rigidity of the front end can be implemented. In the supporting position, at least a part of the front end region is covered, and thus overlapped, in particular directly, by the cross member towards the front in the longitudinal direction of the vehicle. In addition, in the supporting position, the cross member is covered towards the rear in the longitudinal direction of the vehicle by a bodyshell structure of the passenger car, such that, in the event of an application of force caused by an accident, in the supporting position, the cross member can be or is supported on the bodyshell structure towards the rear in the longitudinal direction of the vehicle. The bodyshell structure should be understood to mean at least one region of the bodyshell of the passenger car, also described as a body, and preferably designed as a self-supporting body. As the cross member is overlapped by the bodyshell structure towards the rear in the longitudinal direction of the vehicle in the supporting position, loads for example caused in a frontal impact by an accident can be particularly advantageously absorbed by the cross member and transmitted by the cross member to the bodyshell structure behind it, such that a particularly advantageous behaviour in the event of an accident can be demonstrated.

In the access position, the cross member exposes at least the specified part of the front end region towards the front in the longitudinal direction of the vehicle, such that in the access position, at least the part of the front end region is no longer covered or overlapped towards the front in the longitudinal direction of the vehicle by the cross member. In addition, in the access position, the cross member is arranged lower in the vertical direction of the vehicle than in the supporting position, i.e., in comparison with the supporting position, whereby the front end region is particularly easily and comfortably accessible, in particular for the previously specified person. It is in particular provided that, in the access position, the cross member is no longer covered or overlapped towards the rear in the longitudinal direction of the vehicle by the bodyshell structure, in particular because the cross member is arranged lower than the bodyshell structure in the vertical direction of the vehicle in the access position. The cladding element is displaced from the cladding position into the stowed position, and the cross member is displaced from the supporting position into the access position, in order thus, for example, to create a particularly simple and comfortable accessibility to the front end region. The person can consequently reach the front end region particularly ergonomically.

In a further embodiment of the invention, it is provided that, in the access position, the cross member is arranged without covering the bodyshell structure when viewed rearwards in the longitudinal direction of the vehicle, i.e., is not covered or overlapped by the bodyshell structure or the region, by which the cross member is covered, i.e., overlapped, towards the rear in the longitudinal direction of the vehicle in the supporting position, in order thus to create a comfortable and ergonomic accessibility to the front end region.

In a further embodiment of the invention, it is provided that the bodyshell structure is an upper longitudinal member plane, i.e., at least a region of an upper longitudinal member plane, in order to implement a particularly high rigidity and a particularly good accessibility to the front end region. It is in particular conceivable that the upper longitudinal member plane has at least or exactly two upper longitudinal members, which are spaced apart from each other in the transverse direction of the vehicle and can, for example, be connected to each other via the cross member which extends at least substantially in the transverse direction of the vehicle. For example, the cross member is directly connected to the upper longitudinal member, in particular to respective front ends of the upper longitudinal member. It is further conceivable that the cross member is connected to the upper longitudinal members via respective energy absorption elements. In other words, it can be provided that, at least in the supporting position, the cross member can be or is supported towards the rear in the longitudinal direction of the vehicle on the bodyshell structure, in particular on the upper longitudinal member plane and most particularly on the upper longitudinal members via energy absorption elements which are in particular spaced apart from one another in the transverse direction of the vehicle, whereby a particularly good energy absorption capacity and thus a particularly advantageous behaviour of the front end in the event of an accident can be demonstrated.

The energy absorption elements are also described as energy absorbers and can, for example, be deformed in the event of a frontal collision, thereby absorbing energy. It is conceivable that the cross member can be displaced relative to the energy absorption elements between the supporting position and the access position. As an alternative, it is conceivable that the energy absorption elements can be displaced, and thus moved, with the cross member between the supporting position and the access position. For example, the energy absorption elements are integrated into the cross member. The energy absorption elements form a so-called crash structure, for example, which can be displaced with the upper cross member, and can for example be integrated into the upper cross member. For example, the cross member can be folded, in particular pivoted, between the supporting position and the access position, such that for example the upper cross member is a structure which can be folded or folded away. In particular, the upper cross member can be a mounting member, on which, for example, at least one component, e.g., a radiator, can be held.

In a further embodiment of the invention, it is provided that the bodyshell structure is arranged above a main longitudinal member plane of the passenger car in the vertical direction of the vehicle, to the main longitudinal member plane of which passenger car a front flexible cross member is connected, so that, on the one hand, an advantageous accessibility to the front end region and, on the other hand, a particularly advantageous behaviour of the front end, and thus of the passenger car as a whole in the event of an accident can simultaneously be demonstrated. For example, the main longitudinal member plane comprises at least or exactly two further longitudinal members, which are in particular spaced apart from each other in the transverse direction of the vehicle and which are also described as main longitudinal members. The flexible cross member is for example connected, in particular directly, to the main longitudinal members, in particular to their respective front ends, or the front flexible cross member is connected to the main longitudinal members, in particular to their respective front ends, via respective further energy absorption elements.

In a further embodiment of the invention, it is provided that the cladding element and the cross member can be displaced independently of each other, in order to implement the advantageous accessibility to the front end region in a particularly simple and cost-effective manner. This means, in particular, that, in particular while the cross member is in the supporting position, the cladding element can be displaced between the stowed position and the cladding position without displacing the cross member, in particular from the supporting position, or while the cross member remains in the supporting position. It is thus conceivable, for example, that the cladding element is first displaced from the cladding position into the stowed position, whereupon the cross member is displaced from the supporting position into the access position. It is further conceivable, for example, that in particular while the cladding element is in the stowed position, the cross member can be displaced between the supporting position and the access position without displacing the cladding element, i.e., while the cladding element remains in the stowed position. Thus, for example, the cross member is first displaced from the access position into the supporting position, whereupon the cladding element is displaced from the stowed position into the cladding position.

In a further embodiment of the invention, it is provided that the cladding element and the cross member are coupled with each other, and can thus be displaced together, i.e., simultaneously, in order to implement a particularly good usability in a particularly comfortable manner. At least a part of the displacement of the cladding element between the cladding position and the stowed position is thus implemented simultaneously with at least a part of the displacement of the cross member between the supporting position and the access position. It is in particular conceivable that the cross member can be displaced via the cladding element. In other words, the cross member can for example be displaced by displacing the cladding element, such that for example the previously specified person displaces the cladding element, in particular manually, whereby the displacement of the cross member is associated with the displacement of the cladding element or the displacement of the cross member can be caused by displacing the cladding element. The cladding element and the cross member can thus be particularly comfortably displaced.

In a further embodiment of the invention, the front end has a front storage space, which is also described as a front boot or frunk (front trunk), in order to implement a particularly good usability of the front end. It is provided that the front end region is arranged above at least a partial region of the storage space in the vertical direction of the vehicle. For example, the front end region is at least a part of the storage space. In particular, it is conceivable that the front end region is the storage space, or the front end region is a further partial region of the storage space, wherein the further partial region is arranged above the first partial region in the vertical direction of the vehicle. The storage space is particularly comfortably and ergonomically accessible via the front end region, such that a particularly good usability of the front end can be demonstrated.

It has finally proved particularly advantageous if the front end has a front flap, which can be moved, in particular pivoted, between a closed position and at least one open position, in particular relative to the previously specified component. In the closed position, the front flap at least partially covers the storage space upwards in the vertical direction of the vehicle. In the open position, the flap at least partially exposes the storage space upwards in the vertical direction of the vehicle.

For example, the previously specified component is the bodyshell structure or the flexible cross member. In other words, the cladding element, and preferably also the cross member, can for example be displaced relative to the bodyshell structure, and preferably also relative to the flexible cross member and the main longitudinal members, between the cladding position and the stowed position, or between the supporting position and the access position.

A second aspect of the invention relates to a passenger car having a front end according to the first aspect of the invention. Advantages and advantageous embodiments of the first aspect of the invention should be seen as advantages and advantageous embodiments of the second aspect of the invention and vice versa.

Preferably, the passenger car is designed as an electric vehicle, in particular as a battery electric vehicle (BEV). The passenger car has at least one in particular front electric engine, which is arranged in the front end also described as a front part. The passenger car can be driven electrically, in particular purely electrically, by means of the electric engine. By using the electric engine, in particular in place of a combustion engine, to drive the passenger car, the front storage space can be designed to be particularly large, such that a particularly good usability can be demonstrated. It can be a challenge, in particular with regard to the front storage space, to make loading and unloading the front storage space, also described as a front boot, advantageously ergonomic, in particular such that the front storage space can be particularly comfortably and ergonomically loaded and unloaded. The front storage space can have or be a deep trough, which can conventionally, and in particular in relation to the frontmost end of the passenger car, be arranged far back in the longitudinal direction of the vehicle. The front storage space or the trough can consequently only be accessed with difficulty in conventional solutions, because a person who would like to load or unload the storage space must lean over the frontmost end and front components. This issue is further significantly worsened if the passenger car is not, for example, designed as a saloon car, but rather as an off-road vehicle, e.g., an SUV. Due to a standing height of the passenger car which is significantly higher than that of a saloon car and due its design language, in particular at the front, accessing the storage space may become even more difficult. This problem can be avoided by the invention, however, because the cladding element and preferably also the cross member, which might negatively impact the access to the storage space, can be displaced. Thus, for example, a loading sill, which needs to be crossed to load and unload the front storage space, can be lowered in height or be arranged particularly low, such that the front storage space can be loaded and unloaded particularly ergonomically and comfortably. A particularly advantageous behaviour in the event of an accident and a particularly advantageous rigidity, in particular torsional rigidity, of the front end can simultaneously be guaranteed, in particular by using the cross member. In addition, the cross member can make it possible to absorb loads caused by an accident, for example in the event of a frontal collision, and to transmit the loads to structures behind it, e.g., the specified bodyshell structure, in particular to the upper longitudinal members.

Further advantages and details of the invention result from the following description and with reference to the drawings.

### BRIEF DESCRIPTION OF THE DRAWINGS

FIG. 1 shows a schematic and sectional side view of a front end of a passenger car, wherein a cladding element is in its cladding position;

FIG. 2 shows a schematic and sectional side view of the front end, wherein the cladding element is in its stowed position;

FIG. 3 shows a schematic perspectival view of an assembly of the front end; and

FIG. 4 shows a schematic and sectional perspectival view of the assembly according to FIG. 3.

### DETAILED DESCRIPTION OF THE DRAWINGS

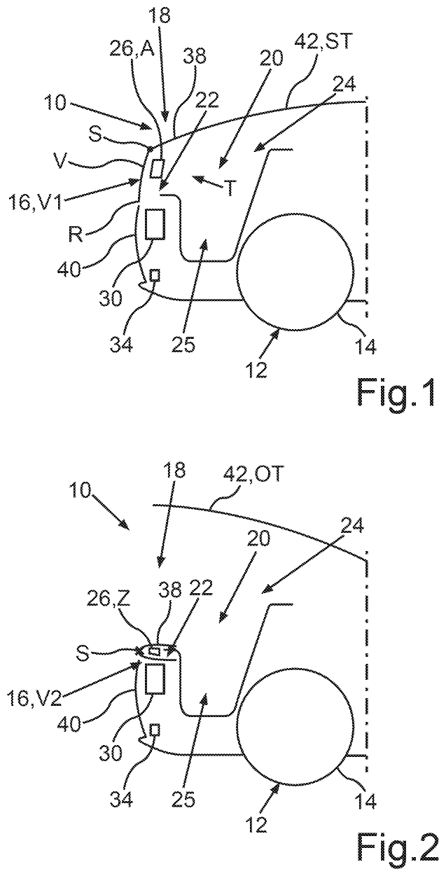

FIG. 1 shows, in a schematic and sectional side view, a front end 10 of a passenger car. The passenger car has exactly two vehicle axles arranged following one after the other in the longitudinal direction of the vehicle, wherein the respective vehicle axle has exactly two vehicle wheels spaced apart from each other in the transverse direction of the vehicle and in particular arranged coaxially with each other. A first of the axles is a front axle, which can be partially seen in FIG. 1, and which is labelled 12. The second axle is a rear axle arranged behind the front axle 12 in the longitudinal direction of the vehicle. In FIG. 1, one of the vehicle wheels of the front axle 12 can be seen, and is labelled 14. The front end 10 has at least one front cladding element 16, which is thus arranged on the front 18 of the passenger car or of the front end 10. The cladding element 16 can be displaced between a cladding position V1 shown in FIG. 1 and at least one stowed position V2 shown in FIG. 2. In the cladding position V1, a front end region 20 is connected to the cladding element 16 towards the rear in the longitudinal direction of the vehicle, which front end region is covered, and thus overlapped, towards the front in the longitudinal direction of the vehicle by the cladding element 16 in the cladding position V1. In the stowed position V2, the cladding element 16 exposes the front end region 20 towards the front in the longitudinal direction of the vehicle, such that the front end region 20 is no longer covered or overlapped by the cladding element 16 towards the front in the longitudinal direction of the vehicle in the stowed position V2.

The cladding element 16 has an edge region R and a cladding region V directly connected to the edge region R, by which cladding region V the front end region 20 is for example covered towards the front in the longitudinal direction of the vehicle at least substantially, in particular completely, in the cladding position V1. The edge region R is a lower edge region R of the cladding element 16 in the vertical direction of the vehicle in relation to the cladding position V1, wherein the cladding region V is directly connected to the edge region R upwards in the vertical direction of the vehicle in the stowed position V1.

The cladding element 16 can be displaced from the cladding position V1 into the stowed position V2, which in particular is lower than the cladding position V1, such that when at least the cladding region V is pivoted forwards in the longitudinal direction of the vehicle and downwards in the vertical direction of the vehicle, the lower edge region R can be retracted rearwards in the longitudinal direction of the vehicle into a corresponding receiving chamber 22 of the front end 10, also described as a receiving region, so that a particularly advantageous usability of the front end 10, and thus of the passenger car as a whole can be implemented. This means that, in order to move the cladding element 16 from the cladding position V1 into the stowed position V2—the cladding element 16 is pivoted around a pivot axis running in the transverse direction of the vehicle such that at least the cladding region V is pivoted forwards in the longitudinal direction of the vehicle and downwards in the vertical direction of the vehicle, and such that the cladding element 16 is shifted, in particular translationally, rearwards in the longitudinal direction of the vehicle, such that the edge region R is retracted, i.e., is moved in particular translationally, rearwards in the longitudinal direction of the vehicle into the receiving chamber 22. If the cladding element 16 is in the stowed position V2, the front end region 20 is thus particularly easily, comfortably and ergonomically accessible for a person standing in front of the front 18 of the passenger car, because the cladding element 16 does not or at least does not substantially protrude over the front end region 20 forwards in the longitudinal direction of the vehicle. This means that, when viewed in the longitudinal direction of the vehicle, the person can position themselves particularly close to the front end region 20, and for example reach into the front end region 20 without needing to bend or stoop excessively.

In the exemplary embodiment shown in the Fig., the front end 10 has a front storage space 24 also described as a front boot, the front storage space having a first partial region 25. The front end region 20 is arranged above the first partial region 25 in the vertical direction of the vehicle, with the front end region 20 and the partial region 25 being connected to each other. In the exemplary embodiment shown in the Fig., the front end region 20 is a second partial region of the front storage space 24, such that the front storage space 24 is particularly easily, ergonomically and comfortably accessible via the front end region 20 if the cladding element 16 is in the stowed position V2. The storage space 24 can thus be loaded and unloaded particularly easily, ergonomically and comfortably.

In vehicles, in particular in high vehicles, which have a luggage compartment, e.g., the storage space 24 in their front part or front end region, the issue usually arises that the person standing in front of the front 18 has to lean far forwards and down when loading and unloading the luggage compartment, because there is usually a rigid transverse structure in the upper region of the vehicle front. This is not particularly comfortable. The rigid cross member structure can for example comprise a so-called radiator bridge and optionally further cross member structures, wherein a front hood lock can, for example, be arranged on the radiator bridge. This cross member structure, in particular with a connection to the bodyshell structure, can however ensure a sufficiently low level of intrusion of a collision partner in the event of an accident, e.g., on impact with a bollard. Without the cross member structure or without the radiator bridge, an obstacle would be able to intrude far into a clearance between the longitudinal member and the front part region if no appropriate countermeasures are taken.

In the front end 10 also described as a front part, the front cladding element 16 can be displaced from the cladding position V1 into the lower-lying cladding position V2, such that the cladding element 16 is retracted into the receiving chamber 22 with its lower edge region R rearwards in the longitudinal direction of the vehicle, and thus in the direction of the passenger compartment of the passenger car. Access to or into the front end region 20 lying behind the cladding element 16, also described as a front part region, is thus given in the longitudinal direction of the vehicle (x direction). For example, the cladding position VI is a first functional position of the cladding element 16, which is in particular arranged in the first functional position during a normal operation of the passenger car. The stowed position V2 is a second functional position, which guarantees simple, comfortable and ergonomic access to the front end region 20. An advantage of the front end 10 is that the cladding element 16 is not simply folded away forwards, which would lead the person to have to stand far away from the front end region 20 in the longitudinal direction of the vehicle, but rather the cladding element 16 is (also) shifted backwards in the longitudinal direction of the vehicle, such that the edge region R is shifted into the corresponding receiving chamber 22. In its stowed position V2, the cladding element 16 is thus located sufficiently far back that the person can stand close to the front end region 20 when viewed in the longitudinal direction of the vehicle.

The front end 10 has an upper cross member 26, which is for example an upper cross member structure or a component of such an upper cross member structure, so that a particularly advantageous rigidity and a particularly advantageous behaviour in the event of an accident can be implemented. The upper cross member 26 can be displaced between a supporting position Al shown in FIG. 1 and an access position Z shown in FIG. 2. In the supporting position A, at least a part of the front end region 20 is covered, and thus overlapped, towards the front in the longitudinal direction of the vehicle by the cross member 26, wherein the specified part of the front end region 20 is labelled T. In addition, in the supporting position A, the upper cross member 26 is covered towards the rear in the longitudinal direction of the vehicle by a bodyshell structure of the passenger car not depicted in more detail in the Fig. In the supporting position A, the cross member 26 is thus or can thus be supported towards the rear in the longitudinal direction of the vehicle on the bodyshell structure, such that, for example, in the event of a frontal collision of the passenger car, loads caused by the accident can be particularly advantageously absorbed by the upper cross member 26 located in the supporting position A, and be diverted to the bodyshell structure located behind it. Excessive intrusions can thus be avoided. In other words, in the supporting position A, in the event of a frontal collision the upper cross member 26 can be supported on the bodyshell structure located behind it, which can be a component of a body support structure or be designed as a body support structure, and can thus contribute to safety in the event of an accident. In the access position Z, the upper cross member 26 is sunken in relation to the supporting position A, because the cross member 26 is arranged lower in the vertical direction of the vehicle in the access position Z than in the supporting position A. In the access position Z, the cross member 26 thus exposes at least the part T towards the front in the longitudinal direction of the vehicle, such that, in the access position Z, the part T is no longer covered by the cross member 26 towards the front in the longitudinal direction of the vehicle. The front end region 20, and thus the front storage compartment 24 as a whole, can thus be accessed particularly easily, comfortably and ergonomically.

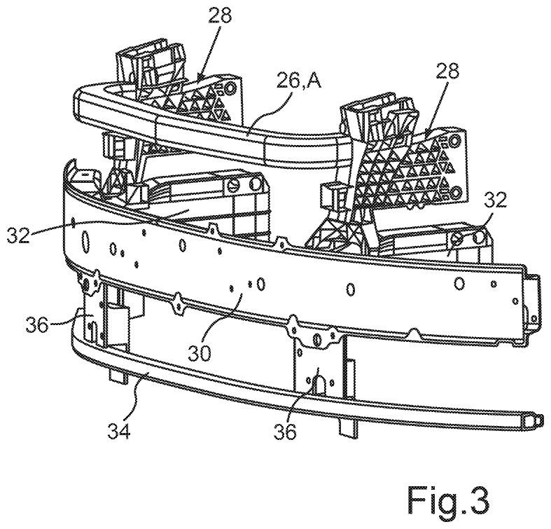

The specified bodyshell structure is, for example, an upper longitudinal member plane, which has two upper first longitudinal members which are spaced apart from each other in the transverse direction of the vehicle. One energy absorption element 28 (FIG. 3) also described as an energy absorber is, for example, provided per first longitudinal member, wherein at least in the supporting position A, the cross member 26 can be or is supported on the first longitudinal members towards the rear in the longitudinal direction of the vehicle via the energy absorption elements 28. It is in particular conceivable that, at least in the supporting position A, the cross member 26 is connected to the bodyshell structure, in particular to the first longitudinal members, via the energy absorption elements 28. The energy absorption elements 28 can, for example, be deformed in the event of a frontal collision, thereby absorbing energy, whereby a particularly advantageous behaviour in the event of an accident can be demonstrated.

The front end 10 can have a further longitudinal member plane in the form of a main longitudinal member plane, which is also described as a lower longitudinal member plane, arranged below the bodyshell structure, in particular the upper longitudinal member plane, in the vertical direction of the vehicle. The main longitudinal member plane has two second longitudinal members, which are also described as main longitudinal members, and which are spaced apart from each other in the transverse direction of the vehicle. A front flexible cross member 30 is connected to the main longitudinal member, and thus to the main longitudinal member plane, the flexible cross member being arranged further down in the vertical direction of the vehicle than the cross member 26 at least when the cross member 26 is located in the supporting position A. One further energy absorption element 32 also described as a crash box is in particular provided per main longitudinal member. The flexible cross member 30 is, for example, connected to the main longitudinal member via the energy absorption elements 32. In the exemplary embodiment shown in the Fig., the front end 10 has a third transverse element 34, which is arranged further down than the flexible cross member 30 in the vertical direction of the vehicle. The transverse element 34 is a so-called lower stiffener, which can implement a particularly advantageous pedestrian protection. For example, if a pedestrian collides with the front 18, the pedestrian, in particular their legs, can be particularly advantageously shifted by means of the transverse element 34, such that a particularly advantageous movement of the pedestrian is caused. Excessive injuries to the pedestrian can thus be avoided. In the exemplary embodiment shown in the Fig., the lower transverse element 34 is connected to the flexible cross member 30 via struts 36 also described as vertical struts. The struts 36 for example extend downwards in the vertical direction of the vehicle away from the flexible cross member 30.

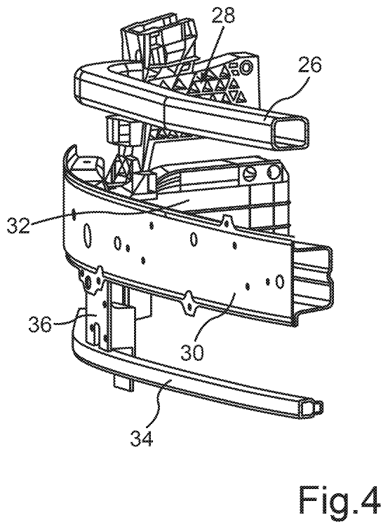

As can be seen from FIG. 4, the upper cross member 26, the flexible cross member 30 and the lower transverse element 34 are profiles, in particular hollow profiles, which respectively have at least or exactly one or, in particular with regard to the lower transverse element 34, several, and thus at least or exactly two hollow chambers.

It is conceivable that exactly one cladding element is provided, in particular in the form of the cladding element 16, via which, in its cladding position V1, the front end region 20 is covered, and thus overlapped, towards the front in the longitudinal direction of the vehicle. In the exemplary embodiment shown in the Fig., however, the cladding element 16, and at least or exactly one second cladding element 38 are provided, wherein the cladding elements 16 and 38 are designed separately from each other. The cladding elements 16 and 38 are articulatedly coupled with each other, in particular by means of a joint or hinge, such that the cladding element 38 can be displaced with the cladding element 16 between the cladding position V1 and the stowed position V2. In addition, the cladding elements 16 and 38 can be pivoted relative to each other around a pivot axis S when they are displaced between the cladding position V1 and the stowed position V2. If the cladding elements 16 and 38 are displaced from the cladding position V1 into the stowed position V2, in particular in relation to the flexible cross member 30 and relative to the bodyshell structure, then the cladding elements 16 and 38 are pivoted around the pivot axis S relative to each other such that the cladding elements 16 and 38 are pivoted towards each other or folded one onto the other. It can be seen from FIG. 2 that in the stowed position V2, and when the cross member 26 is in the access position Z, the cross member 26 is at least partially covered by the cladding element 38 upwards in the vertical direction of the vehicle and at least partially covered by the connecting element 16 downwards in the vertical direction of the vehicle.

A front bumper cladding 40 can additionally be seen from FIGS. 1 and 2, via which front bumper cladding the flexible cross member 30 is in particular clad at least towards the front in the longitudinal direction of the vehicle. The flexible cross member 30 is thus also described as a bumper flexible cross member.

The front end 10 additionally has a front flap 42, which can be moved between a closed position ST shown in FIG. 1 and an open position OT shown in FIG. 2, in particular relative to the bodyshell structure, and can in particular be pivoted around a pivot axis preferably running in the transverse direction of the vehicle. For example, a lock also described as a hood lock or flap lock is arranged on the cross member 26, by means of which lock the front flap 42 can be kept in the closed position ST relative to the cross member 26. In the closed position ST, the front end region 20 and the front storage space 24 are respectively at least partially covered by the front flap 42, which is also described as a front hood, upwards in the vertical direction of the vehicle. In the open position OT, however, the front flap 42 at least partially exposes the front end region 20 and the front storage space 24 respectively, such that when the front flap 42 is in the open position OT, the cladding elements 16 and 38 are in the stowed position V2, and the upper cross member 26 is in the access position Z, the front storage space 24 can be particularly easily, comfortably and ergonomically loaded and unloaded by a person standing in front of the front 18 of the passenger car.

1.-10. (canceled)

11. A front end (10) of a passenger car, comprising:
a front cladding element (16) which is displaceable between a cladding position (V1), in which a front end region (20) which is connected to the front cladding element (16) towards a rear in a longitudinal direction of the passenger car is covered towards a front in the longitudinal direction of the passenger car by the front cladding element (16), and a stowed position (V2), which exposes at least the front end region (20) towards the front in the longitudinal direction of the passenger car;
wherein the front cladding element (16) has, at least in the cladding position (V1), a lower edge region (R) in a vertical direction of the passenger car and a cladding region (V) connected to the lower edge region (R) upwards in the vertical direction of the passenger car;
wherein the front cladding element (16) is displaceable from the cladding position (V1) into the stowed position (V2) such that when at least the cladding region (V) is pivoted forwards in the longitudinal direction of the passenger car and downwards in the vertical direction of the passenger car, the lower edge region (R) is retractable backwards in the longitudinal direction of the passenger car into a receiving chamber (22).

12. The front end (10) according to claim 11, wherein an upper cross member (26) which is displaceable between a supporting position (A), in which at least a part (T) of the front end region (20) is covered towards the front in the longitudinal direction of the passenger car by the upper cross member (26) and the upper cross member (26) is covered by a bodyshell structure of the passenger car towards the rear in the longitudinal direction of the passenger car, and an access position (Z), which exposes at least the part (T) towards the front in the longitudinal direction of the passenger car, in which access position the upper cross member (26) is disposed lower in the vertical direction of the passenger car than in the supporting position (A).

13. The front end (10) according to claim 12, wherein in the access position (Z), the upper cross member (26) is disposed without overlapping the bodyshell structure when viewed towards the rear in the longitudinal direction of the passenger car.

14. The front end (10) according to claim 12, wherein the bodyshell structure is an upper longitudinal member plane.

15. The front end (10) according to claim 12, wherein the bodyshell structure is disposed in the vertical direction of the passenger car above a main longitudinal member plane of the passenger car and wherein a front flexible cross-member (30) is connected to the main longitudinal member plane.

16. The front end (10) according to claim 12, wherein the front cladding element (16) and the upper cross member (26) are displaceable independently of each other.

17. The front end (10) according to claim 12, wherein the front cladding element (16) and the upper cross member (26) are coupled with each other and are displaceable together.

18. The front end (10) according to claim 11, further comprising a front storage space (24), wherein:
the front end region (20) is disposed at least above a partial region (25) of the front storage space (24) in the vertical direction of the passenger car; and/or
the front end region (20) is at least a part of the front storage space (24).

19. The front end (10) according to claim 18, further comprising a front flap (42) which is movable between a closed position (ST), which at least partially covers the front storage space (24) upwards in the vertical direction of the passenger car, and an open position (OT) which at least partially exposes the front storage space (24) upwards in the vertical direction of the passenger car.

20. A passenger car, comprising:
the front end (10) according to claim 11.
